(19) United States
(12) Patent Application Publication
(10) Pub. No.: US 2026/0237107 A1
(43) Pub. Date: Aug. 13, 2026

(54) MODEL CONSTRUCTION METHOD AND APPARATUS, VIRTUAL AVATAR GENERATION METHOD AND APPARATUS, DEVICE, AND MEDIUM

(71) Applicant: Beijing Zitiao Network Technology Co., Ltd., Beijing (CN)

(72) Inventors: Weihong Zeng, Beijing (CN); Shizun Wang, Beijing (CN); Xu Wang, Beijing (CN)

(21) Appl. No.: 19/156,101

(22) PCT Filed: Feb. 7, 2024
(86) PCT No.: PCT/CN2024/076757

§ 371 Date: Aug. 13, 2025

(30) Foreign Application Priority Data
Feb. 13, 2023 (CN) 202310140447.8

(51) Int. Cl. G06T 11/00

(52) U.S. Cl. CPC G06T 11/00

(57) ABSTRACT

This application discloses a model construction method and apparatus, a virtual avatar generation method and apparatus, a device, and a medium. The method includes: after acquiring avatar parameters to be used and a virtual avatar to be used corresponding to the avatar parameters to be used, first using a pre-constructed virtual avatar generation model to perform model inverse mapping processing on the virtual avatar to be used, to obtain a first latent code; then, inputting the first latent code to a pre-constructed real avatar generation model to obtain a real avatar to be used that is output by the real avatar generation model; and then, using the real avatar to be used and the avatar parameters to be used to construct a virtual avatar parameter determination model.

This application claims priority to Chinese Patent Application No. 202310140447.8, entitled “MODEL CONSTRUCTION METHOD AND APPARATUS, VIRTUAL AVATAR GENERATION METHOD AND APPARATUS, DEVICE, AND MEDIUM”, filed with the China National Intellectual Property Administration on Feb. 13, 2023, the disclosure of which is incorporated herein by reference in its entirety.

### FIELD

This application relates to the technical field of image processing, and in particular, to a model construction method and apparatus, a virtual avatar generation method and apparatus, a device, and a medium.

### BACKGROUND

With the development of Internet technology, the application fields of virtual avatars have become increasingly wide. For example, the virtual avatars can be applied in fields such as social networking, shopping, gaming, or entertainment. The virtual avatar refers to an object (e.g., a character, an animal, and an object) that meets avatar requirements in a particular virtual world.

In practice, in some application scenarios, the user can manually input some virtual avatar parameters (e.g., a hair length and an eye size) to a virtual avatar engine, thereby allowing the virtual avatar engine to render corresponding virtual avatars based on these parameters.

### SUMMARY

This application provides the following technical solutions:

This application provides a model construction method, including:
acquiring avatar parameters to be used and a virtual avatar to be used corresponding to the avatar parameters to be used;
performing model inverse mapping processing on the virtual avatar to be used by using a pre-constructed virtual avatar generation model, to obtain a firs latent code;
inputting the first latent code to a pre-constructed real avatar generation model to obtain a real avatar to be used that is output by the real avatar generation model, where the virtual avatar generation model refers to a fine-tuning processing result of the real avatar generation model; and
constructing a virtual avatar parameter determination model by using the real avatar to be used and the avatar parameters to be used.

In a possible implementation, the real avatar generation model is used to output real avatar data for a second latent code;
the virtual avatar generation model is used to output virtual avatar data for the second latent code;
an object in the real avatar data and an object in the virtual avatar data are in a similar state in a first descriptive dimension; and the object in the real avatar data and the object in the virtual avatar data are in a dissimilar state in a second descriptive dimension.

In a possible implementation, the real avatar generation model includes a first network layer and a second network layer, the first network layer is used to determine image pixel information under the first descriptive dimension, and the second network layer is used to determine image pixel information under the second descriptive dimension.

The virtual avatar generation model includes the first network layer and a third network layer, and the third network layer refers to a fine-tuning processing result of the second network layer.

In a possible implementation, the first descriptive dimension at least includes an object structure, and the second descriptive dimension at least includes an image style.

In a possible implementation, before the performing model inverse mapping processing on the virtual avatar to be used by using a pre-constructed virtual avatar generation model, to obtain a first latent code, the method further includes:
constructing a real avatar generation model by using at least one real avatar sample; and
performing fine-tuning processing on the real avatar generation model by using at least one virtual avatar sample, to obtain a virtual avatar generation model.

In a possible implementation, before the performing fine-tuning processing on the real avatar generation model by using at least one virtual avatar sample, to obtain a virtual avatar generation model, the method further includes:
after acquiring an avatar parameter sample, generating the virtual avatar sample corresponding to the avatar parameter sample using a virtual avatar engine

In a possible implementation, the real avatar generation model and the virtual avatar generation model both belong to a generative adversarial network model.

In a possible implementation, a process of acquiring a virtual avatar to be used corresponding to the avatar parameters to be used includes:
after acquiring the avatar parameters to be used, generating the virtual avatar to be used corresponding to the avatar parameters to be used using a virtual avatar engine.

An embodiment of this application provides a virtual avatar generation method, including:
acquiring a target real avatar;
inputting the target real avatar to a pre-constructed virtual avatar parameter determination model to obtain a target avatar parameter output by the virtual avatar parameter determination model, where the virtual avatar parameter determination model is constructed using the model construction method according to this application; and
inputting the target avatar parameter to a virtual avatar engine to obtain a virtual avatar output by the virtual avatar engine.

This application provides a model construction apparatus, including:
a first generation unit, configured to acquire avatar parameters to be used and a virtual avatar to be used corresponding to the avatar parameters to be used;
a second generation unit, configured to perform model inverse mapping processing on the virtual avatar to be used by using a pre-constructed virtual avatar generation model, to obtain a first latent code;
a third generation unit, configured to input the first latent code to a pre-constructed real avatar generation model to obtain a real avatar to be used that is output by the real avatar generation model, where the virtual avatar generation model refers to a fine-tuning processing result of the real avatar generation model; and
a first construction unit, configured to construct a virtual avatar parameter determination model by using the real avatar to be used and the avatar parameters to be used.

This application provides a virtual avatar generation apparatus, including:
an avatar acquiring unit, configured to acquire a target real avatar;
a parameter determination unit, configured to input the target real avatar to a pre-constructed virtual avatar parameter determination model to obtain a target avatar parameter output by the virtual avatar parameter determination model, where the virtual avatar parameter determination model is constructed using the model construction method according to this application; and
an avatar generation unit, configured to input the target avatar parameter to a virtual avatar engine to obtain a virtual avatar output by the virtual avatar engine.

This application provides an electronic device. The device includes a processor and a memory;
the memory is configured to store an instruction or a computer program; and
the processor is configured to execute the instruction or the computer program in the memory to cause the electronic device to perform the model construction method or the virtual avatar generation method according to this application.

This application provides a computer-readable medium, having instructions or a computer program stored therein. The instructions or the computer program, when running on a device, causes the device to perform the model construction method or the virtual avatar generation method according to this application.

This application provides a computer program product, including a computer program carried on a non-transitory computer-readable medium, where the computer program includes program code for performing the model construction method or the virtual avatar generation method according to this application.

### BRIEF DESCRIPTION OF THE DRAWINGS

In order to more clearly describe the technical solutions in the embodiments of this application or in the prior art, the accompanying drawings for describing the embodiments or the prior art will be briefly described below. Apparently, the accompanying drawings in the description below show merely some embodiments recited in this application, and those of ordinary skill in the art may still derive other accompanying drawings from these accompanying drawings without creative efforts.

FIG. 1 is a flowchart of a model construction method according to an embodiment of this application;

FIG. 2 is a schematic diagram of a virtual avatar generation process according to an embodiment of this application;

FIG. 3 is a flowchart of a virtual avatar generation method according to an embodiment of this application;

FIG. 4 is a schematic diagram of a structure of a model construction apparatus according to an embodiment of this application;

FIG. 5 is a schematic diagram of a structure of a virtual avatar generation apparatus according to an embodiment of this application; and

FIG. 6 is a schematic diagram of a structure of an electronic device according to an embodiment of this application.

### DETAILED DESCRIPTION OF EMBODIMENTS

Researches show that for a virtual avatar engine, since virtual avatar parameters involved in the virtual avatar engine not only include some discrete parameters (e.g., parameters such as a hairstyle and an eyebrow shape), but also include some continuous parameters (e.g., parameters such as a face length and an eye spacing), a user of the virtual avatar engine needs to consume a long time and make great efforts to design (or adjust) these parameters, resulting in poor generation experience of a virtual avatar for the user.

The researches also show that to solve the problems shown in the content of the previous paragraph, in some related technical solutions, corresponding virtual avatar parameters may be first manually annotated for some real avatar data; and then these real avatar data and the corresponding virtual avatar parameters are used as training data to train a neural network model, so that the model can learn how to determine virtual avatar parameters for a real avatar data in the training process.

The researches further show that for the related technical solution shown in the previous paragraph, since training supervision information (i.e., the virtual avatar parameters corresponding to the real avatar data) serving as a basis for the above training process is determined through manual annotation, costs for acquiring the training supervision information are high (e.g., significant time and resource consumption), resulting in high model construction costs. Since different virtual avatar engines have different image styles, the same real avatar data corresponds to different virtual avatar parameters under the different virtual avatar engines, the training supervision information is typically applicable only to representing a parameter distribution state of one virtual avatar engine, as a result, the training supervision information does not have a generalization capability (i.e., poor mobility), and different virtual avatar parameters need to be manually annotated for different virtual avatar engines, significantly increasing the model construction costs.

Based on the researches shown in the above three paragraphs, an embodiment of this application provides a model construction method and a virtual avatar generation method, which may specifically include: after acquiring avatar parameters to be used and a virtual avatar to be used (e.g., a virtual avatar image) corresponding to the avatar parameters to be used, first using a pre-constructed virtual avatar generation model to perform model inverse mapping processing on the virtual avatar to be used, to obtain a first latent code; then, inputting the first latent code to a pre-constructed real avatar generation model to obtain a real avatar to be used (e.g., a real avatar image) that is output by the real avatar generation model; and then, using the real avatar to be used and the avatar parameters to be used to construct a virtual avatar parameter determination model, so that the virtual avatar parameter determination model may be subsequently used to automatically generate virtual avatar parameters according to real avatar data provided by the user, thereby effectively avoiding adverse effects (e.g., long time consumption) caused by manual input of the virtual avatar parameters, and effectively improving the generation experience of the virtual avatar for the user.

In addition, since the above virtual avatar generation model refers to a fine-tuning processing result of the real avatar generation model, image data respectively generated by the virtual avatar generation model and the real avatar generation model for the same latent code are not only similar in matching (e.g., resembling the same object) but also possess different styles (e.g., one belongs to a style presented in a real world, and the other belongs to a style presented in a particular virtual world), so that the above avatar parameters to be used may represent virtual avatar characteristics (e.g., an eye color and a hair length) that the real avatar to be used in the virtual world that is generated by the two models for the avatar parameters to be used needs exhibit, and then, a tuple (the real avatar to be used and the avatar parameters to be used) conforms to requirements of the training data corresponding to the virtual avatar parameter determination model, thereby achieving the purpose of automatically generating the training data corresponding to the virtual avatar parameter determination model, effectively avoiding the defects (e.g., long time consumption, high resource consumption, and poor training data mobility) caused by manual annotation of the virtual avatar parameters for the real avatar data, and then effectively improving a construction effect of the virtual avatar generation model.

In addition, an executing entity for the model construction method according to this embodiment of this application is not limited in this application. For example, the model construction method according to this embodiment of this application may be applied to a device having a data processing function, such as a terminal device or a server. For another example, the model construction method according to this embodiment of this application may also be implemented with the aid of a data communication process between different devices (e.g., between a terminal device and a server, two terminal devices, or two servers). The terminal device may be a smart phone, a computer, a personal digital assistant (PDA), a tablet computer, or the like. The server may be a standalone server, a cluster server, or a cloud server.

In addition, an executing entity for the virtual avatar generation method according to this embodiment of this application is not limited in this application. For example, the virtual avatar generation method according to this embodiment of this application may be applied to a device having a data processing function, such as a terminal device or a server. For another example, the virtual avatar generation method according to this embodiment of this application may also be implemented with the aid of a data communication process between different devices (e.g., between a terminal device and a server, two terminal devices, or two servers).

In order to make those skilled in the art better understand the solutions of this application, the technical solutions in the embodiments of this application are clearly and completely described in combination with the accompanying drawings in the embodiments of this application as below, and it is apparent that the described embodiments are merely a part rather all embodiments of this application. All other embodiments obtained by those of ordinary skill in the art based on the embodiments of this application without creative efforts shall fall within the scope of protection of this application.

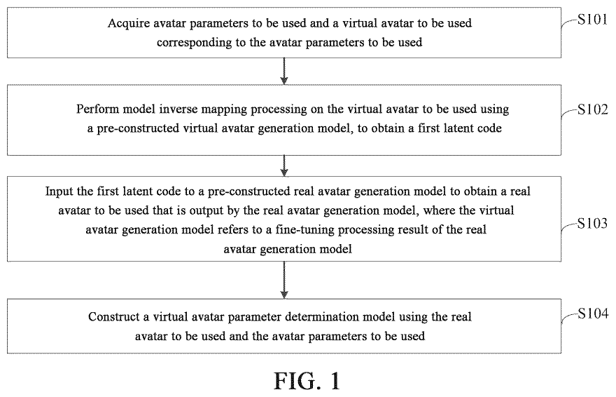

For a better understanding of the technical solutions provided in this application, the model construction method according to this application is first described below in combination with the accompanying drawings. As shown in FIG. 1, the model construction method according to an embodiment of this application includes S101 to S104 below. FIG. 1 is a flowchart of a model construction method according to an embodiment of this application.

S101: Acquire avatar parameters to be used and a virtual avatar to be used corresponding to the avatar parameters to be used.

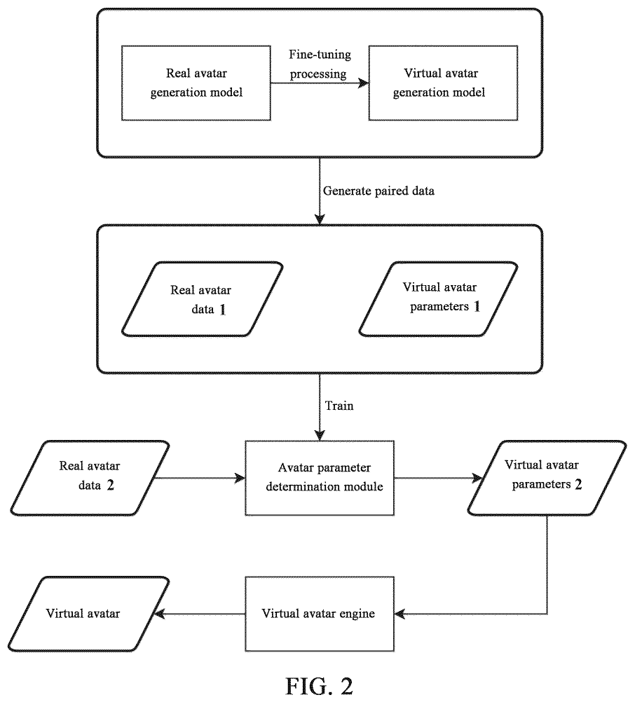

The avatar parameters to be used refer to training supervision information needed in a construction process of a “virtual avatar parameter determination model” mentioned below. Further, this application does not limit a representation method of the avatar parameters to be used, which may be, for example, implemented using a multidimensional vector (e.g., in the vector, first-dimension data refers to a face length, second-dimension data refers to an eye spacing, third-dimension data refers to a hairstyle, and so on). For example, the avatar parameters to be used may be “virtual avatar parameters 1” shown in FIG. 2.

In addition, this application does not limit a process of acquiring the above “avatar parameters to be used”. For example, when the following “virtual avatar parameter determination model” is used to generate virtual avatar parameters under a certain virtual avatar engine (e.g., a “virtual avatar engine” shown in FIG. 2) for real avatar data, the “avatar parameters to be used” may refer to virtual avatar parameters randomly generated for the virtual avatar engine, thereby allowing the “avatar parameters to be used” to conform to a parameter rule (e.g., parameter dimensions and what each dimension of parameters represents) corresponding to the virtual avatar engine. The virtual avatar engine is used to generate a virtual avatar conforming to a certain style (e.g., a certain animation style and an ink painting style). A working principle of the virtual avatar engine includes: inputting a virtual avatar parameter to the virtual avatar engine, and then generating, by the virtual avatar engine, a virtual avatar (e.g., image data and/or a three-dimensional model) based on the virtual avatar parameter.

In addition, this application does not limit the number of the above “avatar parameters to be used”. For example, in some application scenarios, to better improve model performance of the following virtual avatar parameter determination model, the number of the avatar parameters to be used is large, so that a large amount of training data is subsequently generated based on these avatar parameters to be used, and the virtual avatar parameter determination model is constructed based on the large amount of training data.

The above “virtual avatar to be used corresponding to the avatar parameters to be used” belongs to virtual image data, and the “virtual avatar to be used corresponding to the avatar parameters to be used” is used to describe the virtual avatar corresponding to the avatar parameters to be used through certain avatar representation data (e.g., image data), thereby allowing the “virtual avatar to be used corresponding to the avatar parameters to be used” to represent avatar characteristics (e.g., blue eyes and curly hair) presented by the avatar parameters to be used in a certain virtual world.

In addition, this application does not limit an implementation of the above “virtual avatar to be used corresponding to the avatar parameters to be used”, which may be implemented using the image data.

In addition, this application does not limit a process of determining the above “virtual avatar to be used corresponding to the avatar parameters to be used”. For example, when the following “virtual avatar parameter determination model” is used to generate virtual avatar parameters under a certain virtual avatar engine for real avatar data, the process of determining the “virtual avatar to be used corresponding to the avatar parameters to be used” may specifically include: acquiring the avatar parameters to be used and then using the virtual avatar engine to generate the virtual avatar to be used corresponding to the avatar parameters to be used.

It should be noted that this application does not limit an expression method of the real avatar data. For example, expression may be performed using any existing or future avatar representation data (e.g., image data). Similarly, this application does not limit an expression method of the virtual avatar data. For example, expression may be performed using any existing or future avatar representation data (e.g., image data). For ease of understanding, the following is a description of various real avatar data and virtual avatar data represented by the image data.

Based on the relevant content in S101 above, in a possible implementation, when the following “virtual avatar parameter determination model” is used to generate virtual avatar parameters under a certain virtual avatar engine for real avatar data, a large number of virtual avatar parameters (e.g., the above “avatar parameters to be used”) conforming to a parameter rule corresponding to the virtual avatar engine may be first randomly generated; and then, the virtual avatar engine is used to render these virtual avatar parameters to obtain corresponding virtual avatar images (e.g., the above “virtual avatar to be used corresponding to the avatar parameters to be used”), thereby subsequently using these virtual avatar images to generate the real avatar data corresponding to these virtual avatar parameters.

S102: Perform model inverse mapping processing on the virtual avatar to be used by using the pre-constructed virtual avatar generation model, to obtain a first latent code.

The virtual avatar generation model is used to perform virtual avatar data generation processing for input data (e.g., one latent code) of the virtual avatar generation model. For example, the virtual avatar generation model may be the “virtual avatar generation model” shown in FIG. 2.

In addition, this application does not limit an implementation of the above “virtual avatar generation model”, which may be, for example, implemented using a generative adversarial nets (GAN) model. Evidently, in a possible implementation, the virtual avatar generation model belongs to the GAN model. It should be noted that this application does not limit an implementation of the GAN model, which may be, for example, specifically implemented using any existing or future GAN model (e.g., StyleGAN and SemanticStyleGAN).

In other words, in a possible implementation, when the above virtual avatar generation model belongs to the GAN model and the above virtual avatar data belongs to the image data, the virtual avatar generation model may include a generator and a discriminator. The generator is used to perform virtual avatar image generation processing for one latent code. The discriminator is used to perform real and fake discrimination processing for an output result of the generator and a following “virtual avatar sample” in a construction process (e.g., following “fine-tuning processing”) of the virtual avatar generation model, thereby subsequently updating model parameters in the virtual avatar generation model based on a discrimination result.

In addition, this application does not limit the construction process of the above “virtual avatar generation model”, which may specifically, for example, include step 11 to step 12 below.

Step 11: Construct a real avatar generation model by using at least one real avatar sample.

The real avatar sample refers to real avatar data needed in the training process of the above real avatar generation model. The real avatar sample is used for image representation according to a real style (i.e., similar to an image style of image data directly collected from real objects in the real world), thereby allowing the real avatar sample to represent a state presented by one object (e.g., objects such as a face, a certain object, a certain creature, and a certain building) in the real world.

In addition, this application does not limit a method for acquiring the above “at least one real avatar sample”. For example, the “at least one real avatar sample” may be image data obtained after actually shooting some objects in the real world. For another example, it may be implemented using any existing or future image dataset that can participate in GAN model training and conform to the real style.

The above “real avatar generation model” is used to perform real avatar data generation processing for input data of the real avatar generation model. For example, the “real avatar generation model” may be the “real avatar generation model” shown in FIG. 2.

In addition, this embodiment of this application does not limit an implementation of the above real avatar generation model, which may be, for example, implemented using a raw GAN model. Evidently, in a possible implementation, the real avatar generation model belongs to the GAN model. It should be noted that this application does not limit an implementation of the GAN model, which may be, for example, specifically implemented using any existing or future GAN model (e.g., StyleGAN and SemanticStyleGAN).

In addition, this application does not limit an implementation of step 11 above, which may be, for example, implemented using any existing or future method that may train the GAN model.

Based on the relevant content in step 11 above, in a possible implementation, the constructed GAN model may be used as the real avatar generation model, thereby allowing the real avatar generation model to have a real avatar data generation function. The “constructed GAN model” refers to a GAN model obtained after performing training processing on large-scale real avatar data (e.g., large-scale real human face dataset) in advance, thereby allowing the pre-trained GAN model to output real avatar data for any latent code. The latent code refers to input data of the generator in the GAN model. Moreover, this application does not limit a method for acquiring the latent code, which may be, for example, implemented using any existing or further latent code generation method (e.g., random generation).

Step 12: Perform fine-tuning processing on the above real avatar generation model by using the at least one virtual avatar sample, to obtain the virtual avatar generation model.

The virtual avatar sample refers to virtual avatar data needed for constructing the above virtual avatar generation model. The virtual avatar sample is used for image representation according to a target style (e.g., a certain animation style), thereby allowing the virtual avatar sample to represent a state presented by one object (e.g., objects such as a face, a certain object, a certain creature, and a certain building) in the virtual world with the target style. The target style refers to a style presented by the virtual avatar generated by the above “virtual avatar engine”.

In addition, this application does not limit a method for acquiring the above “virtual avatar sample”. For example, when the following “virtual avatar parameter determination model” is used to generate virtual avatar parameters under a certain virtual avatar engine for real avatar data and the virtual avatar engine is used to generate a virtual avatar conforming to the target style, the process of acquiring the above “virtual avatar sample” may specifically include: using the virtual avatar engine to randomly generate some image data under the target style, all of which are determined as the virtual avatar samples. The virtual avatar engine refers to an image generation device pre-constructed for the target style, thereby allowing the virtual avatar engine to automatically generate image data under the target style according to some parameters (e.g., hair configuration parameters and cheek configuration parameters) input by the user or some parameters that are automatically acquired.

Based on the content in the previous paragraph, in a possible implementation, the process of acquiring the above “virtual avatar sample” may specifically include: acquiring an avatar parameter sample and then using the above virtual avatar engine to generate the virtual avatar sample corresponding to the avatar parameter sample. The avatar parameter sample refers to a virtual avatar parameter that is randomly generated and conforms to a parameter rule of the virtual avatar engine.

In addition, this application does not limit an implementation of fine-tuning processing in step 12 above. For example, in the fine-tuning processing process, parameters (e.g., model parameters relevant to a following “second descriptive dimension) involved in all or some of network layers in the above real avatar generation model may be updated, so that image data respectively generated by the virtual avatar generation model obtained after fine-tuning processing and the real avatar generation model for the same latent code are not only similar in matching (e.g., resembling the same object) but also possess different styles (e.g., one belongs to a style presented in the real world, and the other belongs to a style presented in the particular virtual world). For ease of understanding an association relationship between the two models, an example is provided for illustration.

As an example, if the above real avatar generation model is used to output real avatar data for a second latent code and the above virtual avatar generation model is used to output virtual avatar data for the second latent code, an object in the real avatar data and an object in the virtual avatar data are in a similar state in a first descriptive dimension while the object in the real avatar data and the object in the virtual avatar data are in a dissimilar state in the second descriptive dimension, so that the real avatar data and the virtual avatar data are not only similar in matching (e.g., resembling the same object) but also possess different styles (e.g., one belongs to the style presented in the real world, and the other belongs to the style presented in the particular virtual world). The “object in the real avatar data” refers to an object (e.g., a face and an object) appearing in the real avatar data, and the “object in the virtual avatar data” refers to an object (e.g., a face and an object) appearing in the virtual avatar data.

The above “second latent code” refers to a latent code that needs to be processed by the real avatar generation model and the virtual avatar generation model, and the second latent code may refer to any latent code (i.e., a randomly generated latent code).

The above “first descriptive dimension” refers to a data dimension (e.g., the dimension of a “facial structure”) corresponding to similar data distribution rules (e.g., data distribution rules serving as a common basis for the real avatar generation model and the virtual avatar generation model) between a data distribution rule serving as a basis for the above real avatar generation model and a data distribution rule serving as a basis for the above virtual avatar generation model. This application does not limit an implementation of the “first descriptive dimension”. For example, an object structure (e.g., the facial structure) may be at least included, so that the image data respectively generated by the virtual avatar generation model and the real avatar generation model for the same latent code have similar (even identical) object structures. In other words, the data distribution rule serving as the basis for the virtual avatar generation model in the object structure and the data distribution rule serving as the basis for the real avatar generation model in the object structure are similar (even identical). The object structure is used to describe a structure state of an object in image data.

The above “second descriptive dimension” refers to a data dimension (e.g., the dimension of an “image style”) corresponding to data distribution rules that differ significantly (i.e., dissimilar) between the data distribution rule serving as the basis for the above real avatar generation model and the data distribution rule serving as the basis for the above virtual avatar generation model. This application does not limit an implementation of the “second descriptive dimension”. For example, the image style may be at least included, so that the image data respectively generated by the virtual avatar generation model and the real avatar generation model for the same latent code have completely different image styles (e.g., one conforms to the target style, and the other conforms to the real style). In other words, the data distribution rule serving as the basis for the virtual avatar generation model in the image style is completely different from the data distribution rule serving as the basis for the real avatar generation model in the image style.

Based on the content in the above four paragraphs, to achieve an effect described in the above four paragraphs, this embodiment of this application provides a possible implementation for the above real avatar generation model and the above virtual avatar generation model. In this implementation, the real avatar generation model may include a first network layer and a second network layer, and the virtual avatar generation model may include the first network layer and a third network layer. The first network layer is used to determine image pixel information under the first descriptive dimension, the second network layer is used to determine image pixel information under the second descriptive dimension, and the third network layer refers to a fine-tuning processing result of the second network layer. The image pixel information is used to describe pixels existing in the image data. This application does not limit the image pixel information. For example, the image pixel information may include a pixel position, a pixel color, etc.

The above “first network layer” refers to a network layer that does not require parameter update processing in the model fine-tuning processing process. When the data distribution rule serving as the basis for the above real avatar generation model in the first descriptive dimension is similar (even identical) to the data distribution rule serving as the basis for the above virtual avatar generation model in the first descriptive dimension, the first network layer may be used to control the generation of the image pixel information under the first descriptive dimension. Evidently, when the first descriptive dimension includes the above “object structure”, the first network layer may be used to control the generation of the image pixel information under the object structure, so that the first network layer may influence pixel information (e.g., a pixel position and a pixel color) relevant to the object structure that exists in the image data output by the real avatar generation model (or the virtual avatar generation model). It should be noted that when the real avatar generation model belongs to the GAN model, the first network layer refers to one or more network layers in the generator of the GAN model.

The above “second network layer” refers to a network layer that requires parameter update processing in the model fine-tuning processing process. When the data distribution rule serving as the basis for the above real avatar generation model in the second descriptive dimension is completely different from the data distribution rule serving as the basis for the above virtual avatar generation model in the second descriptive dimension, the second network layer may be used to control the generation of the image pixel information under the first descriptive dimension. Evidently, when the second descriptive dimension includes the image style, the second network layer may be used to control the generation of the image pixel information under the image style, so that the second network layer may influence pixel information (e.g., a pixel position and a pixel color) relevant to the image style that exists in the real avatar data output by the real avatar generation model. It should be noted that when the real avatar generation model belongs to the GAN model, the second network layer refers to one or more network layers in the generator of the GAN model.

The above “third network layer” refers to the fine-tuning processing result of the above “second network layer”, so that a data distribution rule serving as a basis for the third network layer in the second descriptive dimension is completely different from a data distribution rule serving as a basis of the second network layer in the second descriptive dimension.

Based on the relevant content in step 11 to step 12 above, in a possible implementation, after acquiring the pre-constructed real avatar generation model, the virtual avatar image (e.g., the above “virtual avatar sample”) randomly generated by the virtual avatar engine may be used to perform fine-tuning processing of the real avatar generation model, to obtain the above virtual avatar generation model, so that the image data respectively generated by the virtual avatar generation model and the real avatar generation model for the same latent code are not only similar in matching (e.g., resembling the same object) but also possess different styles (e.g., one belongs to the style presented in the real world, and the other belongs to the style presented in the particular virtual world).

The above “model inverse mapping processing” refers to a data processing method for determining input data of the virtual avatar generation model on the premise of given output data of the above virtual avatar generation model. Moreover, this embodiment of this application does not limit an implementation of the “model inverse mapping processing”. For example, when the virtual avatar generation model belongs to the GAN model, the “model inverse mapping processing” may be implemented using any existing or future method for performing inverse mapping processing on the GAN model (e.g., GAN inversion based on optimization, or GAN inversion based on an encoder).

The above “first latent code” refers to the input data of the virtual avatar generation model when the above virtual avatar generation model outputs the virtual avatar to be used.

Based on the relevant content in S102 above, for a virtual avatar parameter (e.g., the “virtual avatar parameter 1” shown in FIG. 2), after acquiring the virtual avatar image corresponding to the virtual avatar parameter, the inverse mapping of the pre-constructed virtual avatar generation model (e.g., the “virtual avatar generation model” shown in FIG. 2) may be used to process the virtual avatar image, to obtain the corresponding latent code, so that the real avatar data (e.g., “real avatar data 1” shown in FIG. 2) corresponding to the virtual avatar parameter can be subsequently generated based on the latent code and the above real avatar generation model (e.g., the “real avatar generation model” shown in FIG. 2), thereby achieving the purpose of automatically constructing the training data (the real avatar data and the virtual avatar parameter) using the two image generation sub-models.

S103: Input the first latent code to the pre-constructed real avatar generation model to obtain a real avatar to be used that is output by the real avatar generation model, where the virtual avatar generation model refers to a fine-tuning processing result of the real avatar generation model.

For the relevant content of the real avatar generation model, reference is made to the relevant content in step 11 above, and for brevity, it is not repeated herein.

The real avatar to be used refers to the real avatar data output by the above real avatar generation model for the first latent code. In addition, an object in the real avatar to be used and an object in the above virtual avatar to be used are in a similar state in the first descriptive dimension, and the object in the real avatar to be used and the object in the above virtual avatar to be used are in a dissimilar state in the second descriptive dimension, so that the real avatar to be used and the virtual avatar to be used are not only similar in matching (e.g., resembling the same object) but also possess different styles (e.g., one belongs to the style presented in the real world, and the other belongs to the style presented in the particular virtual world).

Based on the relevant content in S103 above, for a virtual avatar parameter (e.g., the “virtual avatar parameter 1” shown in FIG. 2), after determining the latent code corresponding to the virtual avatar parameter using the pre-constructed virtual avatar generation model, the pre-constructed real avatar generation model performs real avatar data generation processing on the latent code to obtain the real avatar data (e.g., the “real avatar data 1” shown in FIG. 2) corresponding to the virtual avatar parameter, thereby achieving the purpose of automatically constructing the training data (the real avatar data and the virtual avatar parameter) using the two image generation sub-models.

S104: Construct the virtual avatar parameter determination model by using the real avatar to be used and the avatar parameters to be used.

The virtual avatar parameter determination model is used to perform virtual avatar parameter generation processing for input data (e.g., real avatar data) of the virtual avatar parameter determination model. For example, the virtual avatar parameter determination model may be the “virtual avatar parameter determination model” shown in FIG. 2.

In addition, this application does not limit an implementation of S104 above. For example, the implementation may specifically include: after acquiring the real avatar to be used (e.g., the “real avatar data 1” shown in FIG. 2) and the avatar parameters to be used (e.g., the “virtual avatar parameters 1” shown in FIG. 2), determining the tuple (the real avatar to be used and the avatar parameters to be used) as the training data, and using the training data to perform training processing on the neural network model, to obtain the virtual avatar parameter determination model, thereby allowing the virtual avatar parameter determination model to learn how to perform virtual avatar parameter generation processing for the real avatar data. It should be noted that this application does not limit an implementation of the neural network model, which may be, for example, implemented using convolutional neural networks (CNNs) or a transformer.

In addition, this application does not limit a loss function used in the model training process in the previous paragraph. For example, different loss functions may be used for different types of virtual avatar parameters in the training process. For example, a focal loss function is used for discrete virtual avatar parameters (a hairstyle, a face shape, an eyebrow shape, etc.), and an L2 loss function is used for continuous virtual avatar parameters (an eye spacing and a face length).

Based on the relevant content in S101 to S104 above, according to the model construction method provided in this embodiment of this application, after acquiring the avatar parameters to be used and the virtual avatar to be used corresponding to the avatar parameters to be used, the pre-constructed virtual avatar generation model is first used to perform model inverse mapping processing on the virtual avatar to be used, to obtain the first latent code; then, the first latent code is input to the pre-constructed real avatar generation model to obtain the real avatar to be used that is output by the real avatar generation model; and then, the real avatar to be used and the avatar parameters to be used are used to construct the virtual avatar parameter determination model, so that the virtual avatar parameter determination model may be subsequently used to automatically generate the virtual avatar parameters according to the real avatar data provided by the user, thereby effectively avoiding adverse effects (e.g., long time consumption) caused by manual input of the virtual avatar parameters, and effectively improving the generation experience of the virtual avatar for the user.

In addition, since the above virtual avatar generation model refers to the fine-tuning processing result of the real avatar generation model, the image data respectively generated by the virtual avatar generation model and the real avatar generation model for the same latent code are not only similar in matching (e.g., resembling the same object) but also possess different styles (e.g., one belongs to the style presented in the real world, and the other belongs to the style presented in the particular virtual world), so that the above avatar parameters to be used may represent virtual avatar characteristics (e.g., an eye color and a hair length) that the real avatar to be used in the virtual world that is generated by the two models for the avatar parameters to be used needs exhibit, and then, the tuple (the real avatar to be used and the avatar parameters to be used) conforms to requirements of the training data corresponding to the virtual avatar parameter determination model, thereby achieving the purpose of automatically generating the training data corresponding to the virtual avatar parameter determination model, effectively avoiding the defects (e.g., long time consumption, high resource consumption, and poor training data mobility) caused by manual annotation of the virtual avatar parameters for the real avatar data, and then effectively improving a construction effect of the virtual avatar generation model.

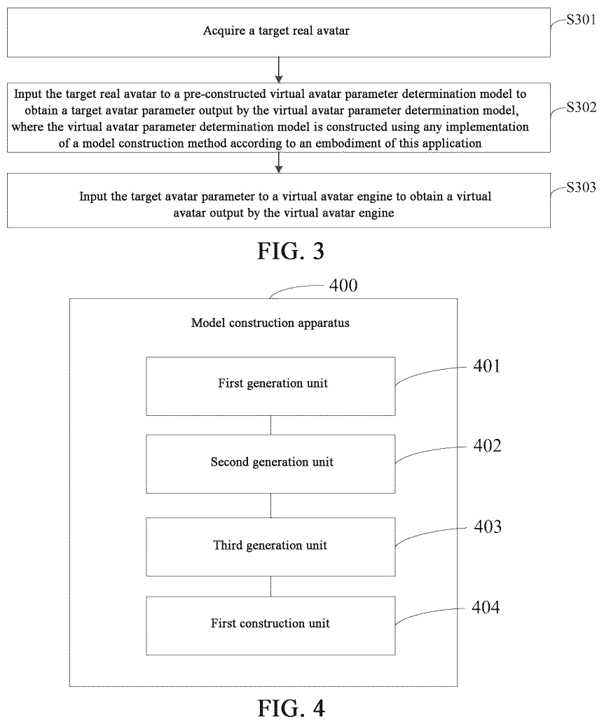

Based on the relevant content of the above model construction method, an embodiment of this application further provides a virtual avatar generation method. For ease of understanding, the following provides a description in combination with FIG. 3. FIG. 3 is a flowchart of a virtual avatar generation method according to an embodiment of this application.

As shown in FIG. 3, the virtual avatar generation method according to this embodiment of this application includes S301 to S303 below.

S301: Acquire a target real avatar.

The target real avatar refers to real avatar data (e.g., the “real avatar data 2” shown in FIG. 2) input by the user, and this application does not limit the target real avatar, which may be, for example, image data captured by the user using a camera device.

S302: Input the target real avatar to a pre-constructed virtual avatar parameter determination model to obtain a target avatar parameter output by the virtual avatar parameter determination model, where the virtual avatar parameter determination model is constructed using any implementation of the model construction method according to the embodiment of this application.

For the relevant content of the virtual avatar parameter determination model, reference is made to the relevant content of the above “model construction method”, and for brevity, it is not repeated herein.

The target avatar parameter refers to the virtual avatar parameter generated by the above virtual avatar parameter determination model for the target real avatar. For example, when the above target real avatar is the “real avatar data 2” shown in FIG. 2, the target avatar parameter may be the “virtual avatar parameter 2” shown in FIG. 2.

S303: Input the target avatar parameter to a virtual avatar engine to obtain a virtual avatar output by the virtual avatar engine.

Based on the relevant content of S301 to S303 above, according to the virtual avatar generation method provided in this embodiment of this application, after acquiring the target real avatar (e.g., selfie image data) provided by the user, the pre-constructed virtual avatar parameter determination model may be first used to perform virtual avatar parameter generation processing for the target real avatar, to obtain the target avatar parameter; and then, the target avatar parameter is input to the virtual avatar engine, so that the virtual avatar engine performs virtual avatar generation processing for the target avatar parameter to obtain and output the virtual avatar (e.g., the “virtual avatar” shown in FIG. 2) corresponding to the target real avatar, accordingly, the virtual avatar and the target real avatar are not only similar in matching (e.g., resembling the same object) but also possess different styles (e.g., one belongs to a style presented in a real world, and the other belongs to a style presented in a particular virtual world), thereby achieving the purpose of using the real avatar data to automatically generate the virtual avatar, effectively avoiding adverse effects caused by a manual parameter input method, and effectively improving the generation experience of the virtual avatar for the user.

Based on the model construction method according to the embodiment of this application, an embodiment of this application also provides a model construction apparatus, which is explained and illustrated below in combination with FIG. 4. FIG. 4 is a schematic diagram of a structure of a model construction apparatus according to an embodiment of this application. It should be noted that, for technical details of the model construction apparatus according to this embodiment of this application, reference may be made to the content related to the above model construction method.

As shown in FIG. 4, the model construction apparatus 400 according to this embodiment of this application includes:
a first generation unit 401, configured to acquire avatar parameters to be used and a virtual avatar to be used corresponding to the avatar parameters to be used;
a second generation unit 402, configured to perform model inverse mapping processing on the virtual avatar to be used by using a pre-constructed virtual avatar generation model, to obtain a first latent code;
a third generation unit 403, configured to input the first latent code to a pre-constructed real avatar generation model to obtain a real avatar to be used that is output by the real avatar generation model, where the virtual avatar generation model refers to a fine-tuning processing result of the real avatar generation model; and
a first construction unit 404, configured to construct a virtual avatar parameter determination model by using the real avatar to be used and the avatar parameters to be used.

In a possible implementation, the real avatar generation model is used to output real avatar data for a second latent code;
the virtual avatar generation model is used to output virtual avatar data for the second latent code;
an object in the real avatar data and an object in the virtual avatar data are in a similar state in a first descriptive dimension; and the object in the real avatar data and the object in the virtual avatar data are in a dissimilar state in a second descriptive dimension.

In a possible implementation, the real avatar generation model includes a first network layer and a second network layer, the first network layer is used to determine image pixel information under the first descriptive dimension, and the second network layer is used to determine image pixel information under the second descriptive dimension.

The virtual avatar generation model includes the first network layer and a third network layer, and the third network layer refers to a fine-tuning processing result of the second network layer.

In a possible implementation, the first descriptive dimension at least includes an object structure, and the second descriptive dimension at least includes an image style.

In a possible implementation, the model construction apparatus 400 further includes:
a second construction unit, configured to construct a real avatar generation model by using at least one real avatar sample; and
a third construction unit, configured to perform fine-tuning processing on the real avatar generation model by using at least one virtual avatar sample, to obtain a virtual avatar generation model.

In a possible implementation, the model construction apparatus 400 further includes:
a fourth generation unit, configured to generate the virtual avatar sample corresponding to the avatar parameter sample using a virtual avatar engine after acquiring an avatar parameter sample.

In a possible implementation, the real avatar generation model and the virtual avatar generation model both belong to a generative adversarial network model.

In a possible implementation, the first generation unit 401 is specifically configured to: acquire the avatar parameters to be used and then use the virtual avatar engine to generate the virtual avatar to be used corresponding to the avatar parameters to be used.

Based on the relevant content of the above model construction apparatus 400, according to the model construction apparatus 400 provided in this embodiment of this application, after acquiring the avatar parameters to be used and the virtual avatar to be used corresponding to the avatar parameters to be used, the pre-constructed virtual avatar generation model is first used to perform model inverse mapping processing on the virtual avatar to be used, to obtain the first latent code; then, the first latent code is input to the pre-constructed real avatar generation model to obtain the real avatar to be used that is output by the real avatar generation model; and then, the real avatar to be used and the avatar parameters to be used are used to construct the virtual avatar parameter determination model, so that the virtual avatar parameter determination model may be subsequently used to automatically generate the virtual avatar parameters according to the real avatar data provided by the user, thereby effectively avoiding adverse effects (e.g., long time consumption) caused by manual input of the virtual avatar parameters, and effectively improving the generation experience of the virtual avatar for the user.

In addition, since the above virtual avatar generation model refers to the fine-tuning processing result of the real avatar generation model, image data respectively generated by the virtual avatar generation model and the real avatar generation model for the same latent code are not only similar in matching (e.g., resembling the same object) but also possess different styles (e.g., one belongs to a style presented in a real world, and the other belongs to a style presented in a particular virtual world), so that the above avatar parameters to be used may represent virtual avatar characteristics (e.g., an eye color and a hair length) that the real avatar to be used in the virtual world that is generated by the two models for the avatar parameters to be used needs exhibit, and then, a tuple (the real avatar to be used and the avatar parameters to be used) conforms to requirements of training data corresponding to the virtual avatar parameter determination model, thereby achieving the purpose of automatically generating the training data corresponding to the virtual avatar parameter determination model, effectively avoiding the defects (e.g., long time consumption, high resource consumption, and poor training data mobility) caused by manual annotation of the virtual avatar parameters for the real avatar data, and then effectively improving a construction effect of the virtual avatar generation model.

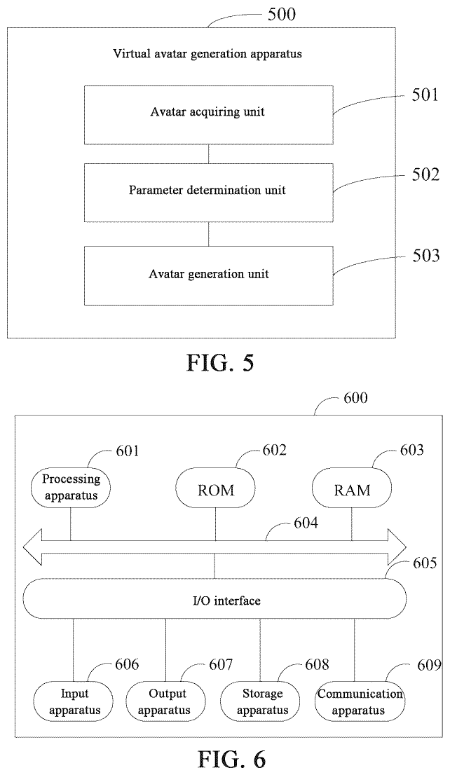

Based on the virtual avatar generation method according to this embodiment of this application, an embodiment of this application further provides a virtual avatar generation apparatus, which is explained and illustrated in combination with FIG. 5 below. FIG. 5 is a schematic diagram of a structure of a virtual avatar generation apparatus according to an embodiment of this application. It should be noted that for technical details of the virtual avatar generation apparatus according to this embodiment of this application, reference is made to the relevant content of the above virtual avatar generation method.

As shown in FIG. 5, the virtual avatar generation apparatus 500 according to this embodiment of this application includes:
an avatar acquiring unit 501, configured to acquire a target real avatar;
a parameter determination unit 502, configured to input the target real avatar to a pre-constructed virtual avatar parameter determination model to obtain a target avatar parameter output by the virtual avatar parameter determination model, where the virtual avatar parameter determination model is constructed using any implementation of the model construction method according to the embodiment of this application; and
an avatar generation unit 503, configured to input the target avatar parameter to a virtual avatar engine to obtain a virtual avatar output by the virtual avatar engine.

Based on the relevant content of the above virtual avatar generation apparatus 500, according to the virtual avatar generation apparatus 500 provided in this embodiment of this application, after acquiring the target real avatar (e.g., selfie image data) provided by the user, the pre-constructed virtual avatar parameter determination model may be first used to perform virtual avatar parameter generation processing for the target real avatar, to obtain the target avatar parameter; and then, the target avatar parameter is input to the virtual avatar engine, so that the virtual avatar engine performs virtual avatar generation processing for the target avatar parameter to obtain and output the virtual avatar corresponding to the target real avatar, accordingly, the virtual avatar and the target real avatar are not only similar in matching (e.g., resembling the same object) but also possess different styles (e.g., one belongs to a style presented in a real world, and the other belongs to a style presented in a particular virtual world), thereby achieving the purpose of using the real avatar data to automatically generate the virtual avatar, effectively avoiding adverse effects caused by a manual parameter input method, and effectively improving the generation experience of the virtual avatar for the user.

In addition, an embodiment of this application further provides an electronic device. The device includes a processor and a memory. The memory is configured to store an instruction or a computer program. The processor is configured to execute the instruction or the computer program in the memory to cause the electronic device to perform any implementation of the model construction method or the virtual avatar generation method according to the embodiments of this application.

Reference is made to FIG. 6, which illustrates a schematic diagram of a structure of an electronic device 600 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (e.g., a central processing unit and a graphics processing unit) 601, which may perform various suitable actions and processing according to a program stored on a read-only memory (ROM) 602 or a program loaded from a storage apparatus 608 into a random access memory (RAM) 603. The RAM 603 further stores various programs and data required for operations of the electronic device 600. The processing apparatus 601, the ROM 602, and the RAM 603 are connected to one another through a bus 604. An input/output (I/O) interface 605 is also connected to the bus 604.

Typically, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard drive; and a communication apparatus 609. The communication apparatus 609 may allow the electronic device 600 to be in wireless or wired communication with other devices for data exchange. Although FIG. 6 shows the electronic device 600 having various apparatuses, it should be understood that it is not required to implement or have all of the shown apparatuses. It may be an alternative to implement or have more or fewer apparatuses.

In particular, the above process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code for performing the method shown in the flowchart. In this embodiment, the computer program may be downloaded and installed from the network through the communication apparatus 609, or installed from the storage apparatus 608, or installed from the ROM 602. The computer program, when executed by the processing apparatus 601, performs the above functions limited in the method in this embodiment of the present disclosure.

The electronic device according to this embodiment of the present disclosure and the method according to the above embodiments belong to the same inventive concept. For the technical details not exhaustively described in this embodiment, reference may be made to the above embodiments, and this embodiment and the above embodiments have the same beneficial effects.

An embodiment of this application further provides a computer-readable medium. The computer-readable medium has an instruction or a computer program stored therein, and the instruction or the computer program, when running on a device, causes the device to perform any implementation of the model construction method or the virtual avatar generation method according to the embodiments of this application.

It should be noted that the above computer-readable medium in the present disclosure may be either a computer-readable signal medium or a computer-readable storage medium, or any combination of the two. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to, an electromagnetic signal, an optical signal, or any suitable combination of the above. The computer-readable signal medium may further be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium, including but not limited to a wire, an optical cable, radio frequency (RF), etc., or any suitable combination of the above.

In some implementations, a client and a server may communicate using any currently known or future-developed network protocols, such as HyperText Transfer Protocol (HTTP), and may also be interconnected with digital data communication in any form or medium (e.g., a communication network). Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The above one or more programs, when executed by the electronic device, cause the electronic device to perform the above method.

Computer program code for performing operations of the present disclosure may be written in one or more programming languages or a combination thereof, where the above programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of the remote computer, the remote computer may be connected to the user computer through any kind of network, including a local area network (LAN) or a wide area network (WAN), or may be connected to an external computer (e.g., connected through the Internet with the aid of an Internet service provider).

The flowchart and the block diagram in the accompanying drawings illustrate the possibly implemented system architecture, functions, and operations of the system, the method, and the computer program product according to various embodiments of the present disclosure. In this regard, each block in the flowchart or the block diagram may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented using a dedicated hardware-based system that performs specified functions or operations, or may be implemented using a combination of dedicated hardware and computer instructions.

The involved units described in the embodiments of the present disclosure may be implemented through software or hardware. The name of the unit/module does not constitute a limitation on the unit itself under certain circumstances.

Herein, the functions described above may be performed at least partially by one or more hardware logic components. For example, without limitation, exemplary hardware logic components that can be used include: a field-programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above content.

It should be noted that the various embodiments in the specification are described in a progressive manner, highlighting the differences between each embodiment and the other embodiments. The similar or identical parts between different embodiments may be cross-referenced to each other. For the system or the apparatus disclosed in this embodiment, since it corresponds to the method disclosed in the embodiments, the description is relatively simple, and for the related parts, reference may be made to the partial description of the method.

It should be understood that in this application, “at least one” refers to one or more, and “a plurality of” refers to two or more. The term “and/or” is an association relationship for describing associated objects, indicating that there may be three relationships. For example, “A and/or B” may represent three situations: A exists alone, B exists alone, and both A and B exist, where A and B may be singular or plural. The character “/” generally indicates an “or” relationship between preceding and succeeding associated objects. “At least one of the following items” or similar expressions refer to any combination of these items, including any combination of single or plural items. For example, at least one of a, b, or c may represent: a, b, c, “a and b”, “a and c”, “b and c”, or “a, b, and c”, where a, b, and c may be single or plural.

It should be further noted that herein, relational terms such as first and second are used only to distinguish one entity or operation from another and do not necessarily require or imply any actual relationship or order between these entities or operations. Moreover, the terms “include”, “contain”, or any of their variants is intended to cover a non-exclusive inclusion, such that a process, a method, an article, or a device that includes a series of elements not only includes those elements but also includes other elements that are not expressly listed, or further includes elements inherent to such process, method, article, or device. In the absence of more restrictions, an element defined by the phrase “including a . . . ” does not exclude another identical element in the process, the method, the article, or the device that includes the element.

The steps of the method or the algorithm described in combination with the embodiments disclosed herein may be implemented directly in hardware, in a software module executed by a processor, or in a combination of the two. The software module may be arranged in a random access memory (RAM), an internal memory, a read-only memory (ROM), an electrically programmable ROM, an electrically erasable programmable ROM, a register, a hard drive, a removable disk, a CD-ROM, or any other form of storage medium known in the art.

Those skilled in the art can implement or use this application according to the above descriptions of the disclosed embodiments. Various modifications to these embodiments are apparent to those skilled in the art, and the general principle defined herein may be implemented in other embodiments without departing from the spirit or scope of this application. Therefore, this application will not be limited to the embodiments shown herein but needs to conform to a widest scope consistent to the principles and novel characteristics disclosed herein.

1. A model construction method, comprising:
acquiring avatar parameters to be used and a virtual avatar to be used corresponding to the avatar parameters to be used;
performing model inverse mapping processing on the virtual avatar to be used using a pre-constructed virtual avatar generation model, to obtain a first latent code;
inputting the first latent code to a pre-constructed real avatar generation model to obtain a real avatar to be used that is output by the real avatar generation model, the virtual avatar generation model referring to a fine-tuning processing result of the real avatar generation model; and
constructing a virtual avatar parameter determination model using the real avatar to be used and the avatar parameters to be used.

2. The method according to claim 1, wherein the real avatar generation model is configured to output real avatar data for a second latent code;
the virtual avatar generation model is configured to output virtual avatar data for the second latent code;
an object in the real avatar data and an object in the virtual avatar data are in a similar state in a first descriptive dimension; and the object in the real avatar data and the object in the virtual avatar data are in a dissimilar state in a second descriptive dimension.

3. The method according to claim 1, wherein the real avatar generation model comprises a first network layer and a second network layer, the first network layer is configured to determine image pixel information under the first descriptive dimension, and the second network layer is configured to determine image pixel information under the second descriptive dimension; and
the virtual avatar generation model comprises the first network layer and a third network layer, and the third network layer refers to a fine-tuning processing result of the second network layer.

4. The method according to claim 2, wherein the first descriptive dimension at least comprises an object structure, and the second descriptive dimension at least comprises an image style.

5. The method according to claim 1, wherein before performing model inverse mapping processing on the virtual avatar to be used using a pre-constructed virtual avatar generation model, to obtain the first latent code, the method further comprises:
constructing the real avatar generation model using at least one real avatar sample; and
performing fine-tuning processing on the real avatar generation model using at least one virtual avatar sample to obtain the virtual avatar generation model.

6. The method according to claim 5, wherein before performing fine-tuning processing on the real avatar generation model using at least one virtual avatar sample to obtain the virtual avatar generation model, the method further comprises:
after acquiring an avatar parameter sample, generating the virtual avatar sample corresponding to the avatar parameter sample using a virtual avatar engine.

7. The method according to claim 1, wherein the real avatar generation model and the virtual avatar generation model both belong to a generative adversarial network model.

8. The method according to claim 1, wherein a process of acquiring the virtual avatar to be used corresponding to the avatar parameters to be used comprises:
after acquiring the avatar parameters to be used, generating the virtual avatar to be used corresponding to the avatar parameters to be used using a virtual avatar engine.

9. A virtual avatar generation method, comprising:
acquiring a target real avatar;
inputting the target real avatar to a pre-constructed virtual avatar parameter determination model to obtain a target avatar parameter output by the virtual avatar parameter determination model, the virtual avatar parameter determination model being constructed by:
acquiring avatar parameters to be used and a virtual avatar to be used corresponding to the avatar parameters to be used;
performing model inverse mapping processing on the virtual avatar to be used using a pre-constructed virtual avatar generation model, to obtain a first latent code;
inputting the first latent code to a pre-constructed real avatar generation model to obtain a real avatar to be used that is output by the real avatar generation model, the virtual avatar generation model referring to a fine-tuning processing result of the real avatar generation model; and
constructing the virtual avatar parameter determination model using the real avatar to be used and the avatar parameters to be used; and
inputting the target avatar parameter to a virtual avatar engine to obtain a virtual avatar output by the virtual avatar engine.

10. (canceled)

11. (canceled)

12. An electronic device, comprising: a processor and a memory, wherein
the memory is configured to store an instruction or a computer program; and
the processor is configured to execute the instruction or the computer program stored in the memory to cause the electronic device to:
acquire avatar parameters to be used and a virtual avatar to be used corresponding to the avatar parameters to be used;
perform model inverse mapping processing on the virtual avatar to be used using a pre-constructed virtual avatar generation model, to obtain a first latent code;
input the first latent code to a pre-constructed real avatar generation model to obtain a real avatar to be used that is output by the real avatar generation model, the virtual avatar generation model referring to a fine-tuning processing result of the real avatar generation model; and
construct a virtual avatar parameter determination model using the real avatar to be used and the avatar parameters to be used.

13. (canceled)

14. The method according to claim 9, wherein the real avatar generation model is configured to output real avatar data for a second latent code;
the virtual avatar generation model is configured to output virtual avatar data for the second latent code;
an object in the real avatar data and an object in the virtual avatar data are in a similar state in a first descriptive dimension; and the object in the real avatar data and the object in the virtual avatar data are in a dissimilar state in a second descriptive dimension.

15. The method according to claim 9, wherein the real avatar generation model comprises a first network layer and a second network layer, the first network layer is configured to determine image pixel information under the first descriptive dimension, and the second network layer is configured to determine image pixel information under the second descriptive dimension; and
the virtual avatar generation model comprises the first network layer and a third network layer, and the third network layer refers to a fine-tuning processing result of the second network layer.

16. The method according to claim 14, wherein the first descriptive dimension at least comprises an object structure, and the second descriptive dimension at least comprises an image style.

17. The electronic device according to claim 12, wherein the real avatar generation model is configured to output real avatar data for a second latent code;
the virtual avatar generation model is configured to output virtual avatar data for the second latent code;
an object in the real avatar data and an object in the virtual avatar data are in a similar state in a first descriptive dimension; and the object in the real avatar data and the object in the virtual avatar data are in a dissimilar state in a second descriptive dimension.

18. The electronic device according to claim 12, wherein the real avatar generation model comprises a first network layer and a second network layer, the first network layer is configured to determine image pixel information under the first descriptive dimension, and the second network layer is configured to determine image pixel information under the second descriptive dimension; and
the virtual avatar generation model comprises the first network layer and a third network layer, and the third network layer refers to a fine-tuning processing result of the second network layer.

19. The electronic device according to claim 17, wherein the first descriptive dimension at least comprises an object structure, and the second descriptive dimension at least comprises an image style.

20. The electronic device according to claim 12, wherein before the processor causing the electronic device to perform model inverse mapping processing on the virtual avatar to be used using a pre-constructed virtual avatar generation model to obtain the first latent code, the processor further causes the electronic device to:
construct the real avatar generation model using at least one real avatar sample; and
perform fine-tuning processing on the real avatar generation model using at least one virtual avatar sample to obtain the virtual avatar generation model.

21. The electronic device according to claim 20, wherein before performing fine-tuning processing on the real avatar generation model using at least one virtual avatar sample to obtain the virtual avatar generation model, the processor further causes the electronic device to:
after acquiring an avatar parameter sample, generate the virtual avatar sample corresponding to the avatar parameter sample using a virtual avatar engine.

22. The electronic device according to claim 12, wherein the real avatar generation model and the virtual avatar generation model both belong to a generative adversarial network model.

23. The electronic device according to claim 12, wherein the processor causing the electronic device to acquire the virtual avatar to be used corresponding to the avatar parameters to be used further causes the electronic device to:
after acquiring the avatar parameters to be used, generate the virtual avatar to be used corresponding to the avatar parameters to be used using a virtual avatar engine.
